(19) United States
(12) Patent Application Publication
(10) Pub. No.: US 2024/0416446 A1
(43) Pub. Date: Dec. 19, 2024

(54) WELDING GUN CONTROL DEVICE, WELDING GUN CONTROL SYSTEM, AND WELDING SYSTEM

(71) Applicant: FANUC CORPORATION, Yamanashi (JP)

(72) Inventors: Masao MOTOHASHI, Yamanashi (JP); Takahiro KITANO, Yamanashi (JP)

(73) Assignee: FANUC CORPORATION, Yamanashi (JP)

(21) Appl. No.: 18/695,141

(22) PCT Filed: Oct. 15, 2021
(86) PCT No.: PCT/JP2021/038238

§ 371 Date: Mar. 25, 2024

(51) Int. Cl. B23K 11/11

(52) U.S. Cl. CPC B23K 11/115

(57) ABSTRACT

Provided is a welding gun control device whereby it is possible to reduce a load placed on a workpiece during workpiece detection in spot welding. This welding gun control device for controlling a welding gun for pressing an object to be welded between a movable electrode driven by a servomotor and a counter electrode facing the movable electrode and performing welding comprises: an operation control unit for causing the movable electrode to move at a first speed in a state in which the object to be welded is disposed between the movable electrode and the counter electrode, and causing the counter electrode or the object to be welded to move at a second speed slower than the first speed; and a workpiece detection unit for detecting the object to be welded on the basis of the operating state of the servomotor for driving the movable electrode, while the movable electrode and the counter electrode are caused to move by the operation control unit.

### TECHNICAL FIELD

The present invention relates to a welding gun control device, a welding gun control system, and a welding system.

### BACKGROUND ART

A welding system for spot welding that detects a workpiece by monitoring a current value of a servomotor has been proposed. For example, according to a welding system disclosed by Patent Document 1, a current or torque of a servomotor of a welding gun is monitored. When a change tendency of the current or torque of the servomotor varies, it is determined that a movable electrode makes contact with or is completely separated from a workpiece to be welded, and the movable electrode is positioned at a point where it is determined that the movable electrode makes contact with or is separated from the workpiece. When the welding system detects the workpiece using the movable electrode, the movable electrode first needs to make contact with the workpiece. Thus, only the movable electrode is usually moved, and a counter electrode is kept stationary.

### CITATION LIST

### Patent Document

Patent Document 1: Japanese Unexamined Patent Application, Publication No. 2011-88177

### DISCLOSURE OF THE INVENTION

### Problems to be Solved by the Invention

In spot welding the workpiece, it is better to make a load applied to the workpiece for the detection of the workpiece smaller because a large load applied to the workpiece may deform the workpiece. Thus, it is required for the spot welding to reduce the load applied to the workpiece in the detection of the workpiece. When the contact between the movable electrode and the workpiece is detected and then the counter electrode is moved to the position of the contact, it is desirable that the vibration of the spot welding gun is reduced and an actual path of the spot welding gun is kept from deviating from an instructed path. The vibration of the spot welding gun may affect the quality of a weld, and the deviation of the actual path from the instructed path may cause a welding point to be misaligned with high possibility.

### Means for Solving the Problems

An aspect according to the present disclosure is directed to a welding gun control device for controlling a welding gun that pressurizes and welds a welding target between a movable electrode driven by a servomotor and a counter electrode facing the movable electrode. The welding gun control device includes: a motion controller that moves the movable electrode at a first speed and moves the counter electrode or the welding target at a second speed lower than the first speed, the welding target being disposed between the movable electrode and the counter electrode; and a detector that detects the welding target based on an operating status of the servomotor driving the movable electrode while the motion controller is moving the movable electrode and the counter electrode.

Another aspect according to the present disclosure is directed to a welding gun control system including: a welding gun that includes a movable electrode driven by a servomotor and a counter electrode facing the movable electrode and pressurizes and welds a welding target between the movable electrode and the counter electrode; and a welding gun control device that controls the welding gun. The welding gun control device includes: a motion controller that moves the movable electrode at a first speed and moves the counter electrode or the welding target at a second speed lower than the first speed, the welding target being disposed between the movable electrode and the counter electrode; and a detector that detects the welding target based on an operating status of the servomotor driving the movable electrode while the motion controller is moving the movable electrode and the counter electrode.

Another aspect according to the present disclosure is directed to a welding system including: a welding gun that includes a movable electrode driven by a servomotor and a counter electrode facing the movable electrode and pressurizes and welds a welding target between the movable electrode and the counter electrode; a welding gun control device that controls the welding gun; a robot that holds the welding gun or the welding target and includes a robot servomotor that drives multiple axes; and a robot control device that controls the servomotor of the welding gun and the robot servomotor. The welding gun control device includes: a motion controller that moves the movable electrode at a first speed and moves the counter electrode or the welding target at a second speed lower than the first speed, the welding target being disposed between the movable electrode and the counter electrode; and a detector that detects the welding target based on an operating status of the servomotor driving the movable electrode while the motion controller is moving the movable electrode and the counter electrode.

### Effects of the Invention

The present invention can reduce a load applied to a workpiece when detecting the workpiece for spot welding. Further, the present invention can reduce vibration of a spot welding gun and can keep the spot welding gun from deviating from an instructed path as compared to a situation where a counter electrode is kept stationary before detecting a contact.

### BRIEF DESCRIPTION OF THE DRAWINGS

FIG. 1 is a view illustrating a configuration of a spot welding system according to a present embodiment;

FIG. 2 is a view illustrating a functional configuration of a welding gun control device;

FIG. 3A is a view illustrating the motion of a movable electrode and a counter electrode;

FIG. 3B is a view illustrating the motion of the movable electrode and the counter electrode;

FIG. 3C is a view illustrating the motion of the movable electrode and the counter electrode;

FIG. 3D is a view illustrating the motion of the movable electrode and the counter electrode;

FIG. 3E is a view illustrating the motion of the movable electrode and the counter electrode;

FIG. 4 is a graph illustrating speed changes of the movable electrode and counter electrode according to a first embodiment;

FIG. 5 is a flowchart of an action of closing a spot welding gun by a welding gun control device according to the first embodiment;

FIG. 6 is a flowchart of an action of closing a spot welding gun by a welding gun control device according to a second embodiment;

FIG. 7 is a view illustrating a configuration of a spot welding system including an X-type spot welding gun; and

FIG. 8 is a view illustrating a configuration of a spot welding system including a fixed spot welding gun.

### PREFERRED MODE FOR CARRYING OUT THE INVENTION

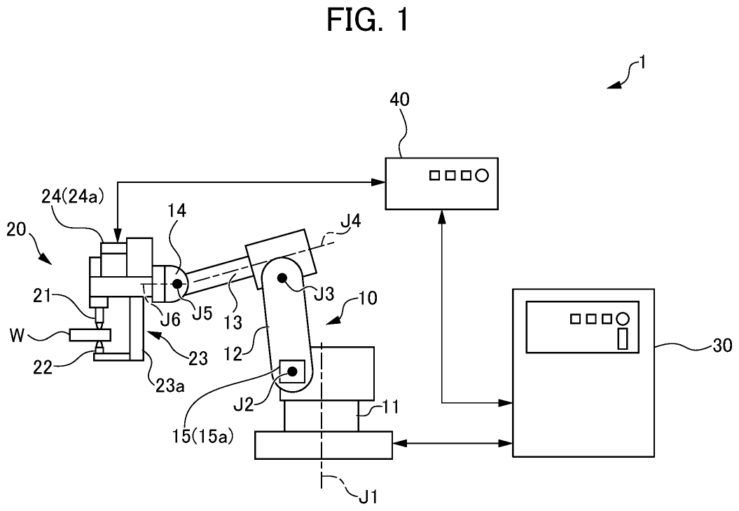

Embodiments of the present invention will be described below with reference to the drawings. FIG. 1 is a view illustrating a configuration of a spot welding system 1 according to the present embodiment. As shown in FIG. 1, the spot welding system 1 uses a robot 10 to move a spot welding gun 20 and a workpiece W relative to each other to bring the spot welding gun 20 into contact with the workpiece W for spot welding the workpiece W. The spot welding system 1 includes the robot 10, the spot welding gun 20, a robot control device 30, and a welding gun control device 40.

The robot 10 is, for example, a six-axis vertically articulated robot, and includes a base 11, a lower arm 12, an upper arm 13, and an arm end 14. The base 11 is placed on the floor. An end of the lower arm 12 is coupled to the base 11 to be rotatable about a first axis (vertical axis) J1 and about a second axis (horizontal axis) J2.

An end of the upper arm 13 is coupled to the other end of the lower arm 12 to be rotatable about a third axis (horizontal axis) J3. The arm end 14 is coupled to the other end of the upper arm 13 to be rotatable about a fourth axis J4 perpendicular to the third axis J3 and about a fifth axis J5 perpendicular to the fourth axis J4. The spot welding gun 20 is coupled to the arm end 14 to be rotatable about a sixth axis J6 perpendicular to the fifth axis J5.

The robot 10 is not limited to the six-axis vertically articulated robot, and any other articulated robot such as a four-axis vertically articulated robot may be used as long as it can move the spot welding gun 20 and the workpiece W relative to each other.

The robot 10 includes multiple servomotors 15 (only one of them is shown in the drawing for convenience's sake), and each of the servomotors drives an associated one of the multiple drive axes including the first to sixth axes J1 to J6. The servomotors 15 are driven by a control signal from the robot control device 30. The position and orientation of the spot welding gun 20 are changed by driving the servomotors 15.

In the following description, the first to sixth axes J1 to J6 of the robot 10 may be referred to as robot axes, and the servomotors 15 for driving the robot axes may be referred to as robot axis motors. The first, second, and third axes J1, J2, and J3 which are vertical or horizontal axes may be referred to as basic axes, and the fourth, fifth, and sixth axes J4, J5, and J6 may be referred to as wrist axes. The basic axes J1 to J3 which are vertical or horizontal axes mainly position the arm end 14 of the robot 10. The wrist axes J4 to J6 mainly determine the orientation of the arm end 14 of the robot 10.

The spot welding gun 20 is a generally called C-type spot welding gun. The spot welding gun 20 includes a C-shaped gun arm 23 coupled to the arm end 14 and a servomotor 24 for sandwiching the workpiece.

The gun arm 23 includes a rod-shaped counter electrode 22 protruding from an end of an L-shaped frame 23a and a rod-shaped movable electrode 21 protruding to face the counter electrode 22. The movable electrode 21 and the counter electrode 22 are coaxially arranged. The counter electrode 22 is fixed to the frame 23a, and the movable electrode 21 is able to move coaxially with the counter electrode 22 relative to the frame 23a.

The movable electrode 21 of the spot welding gun 20 pushes the counter electrode 22 to elastically deform a metal arm to which the counter electrode 22 is attached, generating a required welding pressure between the movable electrode 21 and the counter electrode 22. Thus, the spot welding gun 20 pressurizes and welds the workpiece W which is a welding target.

The servomotor 24 is driven by a control signal from the welding gun control device 40. The movable electrode 21 is driven by the servomotor 24 to move closer to the counter electrode 22 or away from the counter electrode 22. The workpiece W is sandwiched between the movable electrode 21 and the counter electrode 22 in a thickness direction and is spot welded. The workpiece W is supported by a workpiece support which is not shown.

The servomotor 24 for driving the movable electrode 21 may be driven by, for example, an external controller such as the robot control device 30 or a numerical controller, in place of the welding gun control device 40.

In the following description, an axis of the relative movement of the movable electrode 21 and counter electrode 22 of the spot welding gun 20 may be referred to as a gun axis, and the servomotor 24 for driving the gun axis may be referred to as a gun axis motor.

Each of the servomotors 15 for driving the robot axes includes an encoder 15a. The encoder 15a detects an angle of rotation of the servomotor 15 about the axis. The detected angle of rotation is fed back to the robot control device 30. The position and orientation of the spot welding gun 20 at the arm end 14 are controlled based on the feedback control by the robot control device 30. In this way, the spot welding system 1 can position the counter electrode 22 integrated with the frame 23a to sandwich the workpiece W in the thickness direction and can detect the position and orientation of the counter electrode 22 based on the signal from the encoder 15a.

The servomotor 24 for driving the gun axis includes an encoder 24a. The encoder 24a detects an angle of rotation of the servomotor 24 about the axis. The detected angle of rotation is fed back to the welding gun control device 40. The movable electrode 21 is positioned relative to the counter electrode 22 by the feedback control by the welding gun control device 40.

The degree of separation of the movable electrode 21 and the counter electrode 22 varies depending on the angle of rotation of the servomotor 24. In the present embodiment, the spot welding system 1 sets the angle of rotation of the servomotor 24 when the movable electrode 21 is in contact with the counter electrode 22, i.e., when the degree of separation is zero, as a reference value in advance. This allows the spot welding system 1 to detect the angle of rotation relative to the reference value based on the signal from the encoder 24a and to detect the degree of separation of the movable electrode 21 and the counter electrode 22.

Each of the robot control device 30 and the welding gun control device 40 has an arithmetic processing unit including a CPU, a ROM, a RAM, and other peripheral circuits. The robot control device 30 and the welding gun control device 40 are connected to be able to communicate with each other and transmit and receive signals between each other.

The robot control device 30 stores operation programs (work programs) and teaching data for the robot 10 and the spot welding gun 20. The teaching data includes welding point data including the positions and orientations of the robot 10 and the spot welding gun 20 when the workpiece W is spot welded at multiple points. A work program for automatic operation is created based on the teaching data.

During the automatic operation, the robot control device 30 uses the robot 10 to control the position and orientation of the spot welding gun 20 relative to the workpiece W according to the work program so that the workpiece W is disposed between the movable electrode 21 and the counter electrode 22.

The welding gun control device 40 operates the movable electrode 21 according to the work program to control a welding pressure applied to the workpiece W by the movable electrode 21 and the counter electrode 22. Further, the welding gun control device 40 controls a current supplied to the movable electrode 21 and the counter electrode 22 according to the work program to perform the spot welding at a predetermined welding point.

The robot control device 30 or the welding gun control device 40 may be connected to a workpiece support (not shown) for supporting the workpiece W to be able to communicate with and control the workpiece support.

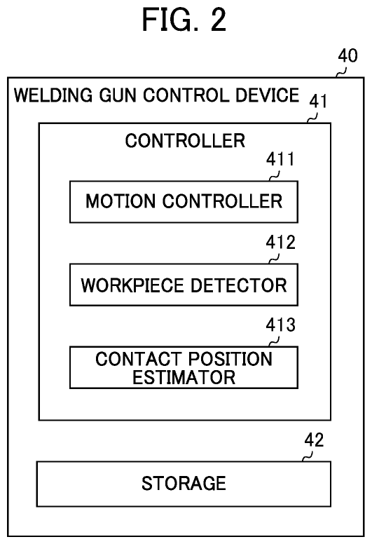

FIG. 2 is a view illustrating a functional configuration of the welding gun control device 40. As shown in FIG. 2, the welding gun control device 40 includes a controller 41 and a storage 42. The controller 41 is a section that controls the whole welding gun control device 40, and may be, for example, a CPU. The controller 41 suitably reads various programs from the storage 42 and achieve various functions by executing the programs. The storage 42 is constituted of a component such as a ROM, a RAM, a flash memory, or a hard disk (HDD) and stores various programs and data.

The controller 41 includes a motion controller 411, a workpiece detector 412 (a detector), and a contact position estimator 413. The motion controller 411 controls the motion of the movable electrode 21 and the counter electrode 22. Specifically, with the workpiece W disposed between the movable electrode 21 and the counter electrode 22, the motion controller 411 moves the movable electrode 21 at a searching speed (first speed) and moves the counter electrode 22 or the workpiece W at a slow speed (second speed) lower than the searching speed.

When the workpiece detector 412 detects the workpiece W, the motion controller 411 decelerates the movable electrode 21 to the first speed. After decelerating the movable electrode, the motion controller 411 accelerates the movable electrode 21 to an abutting speed (third speed) higher than the slow speed (second speed). The searching speed, the slow speed, and the abutting speed will be described in detail later.

When the workpiece detector 412 detects the workpiece W, the motion controller 411 decelerates the movable electrode 21 to the first speed. After decelerating the movable electrode, the motion controller 411 accelerates the movable electrode 21 to an abutting speed (third speed) higher than the slow speed (second speed). The searching speed, the slow speed, and the abutting speed will be described in detail later.

When the workpiece detector 412 detects the workpiece W, the motion controller 411 accelerates the counter electrode 22 to the third speed to move to a target position calculated by the contact position estimator 413.

While the motion controller 411 is moving the movable electrode 21 and the counter electrode 22, the workpiece detector 412 detects the workpiece W based on the operating status of the servomotor 24 driving the movable electrode 21. Specifically, the workpiece detector 412 acquires a current value or speed of the servomotor 24 as the operating status of the servomotor 24. The workpiece detector 412 detects the workpiece W by determining whether the movable electrode 21 and the workpiece W are in contact with each other based on the acquired current value or speed of the servomotor 24. The workpiece detector 412 may determine whether the movable electrode 21 and the workpiece W are in contact with each other by using an external sensor such as a contact sensor.

When the workpiece detector 412 detects the workpiece W, the contact position estimator 413 estimates the position of contact between the movable electrode 21 and the workpiece W and calculates the target position of the counter electrode 22.

### First Embodiment

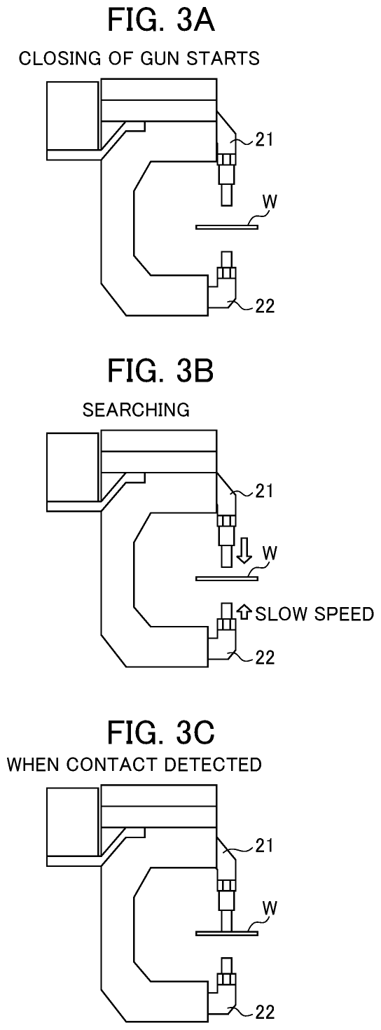

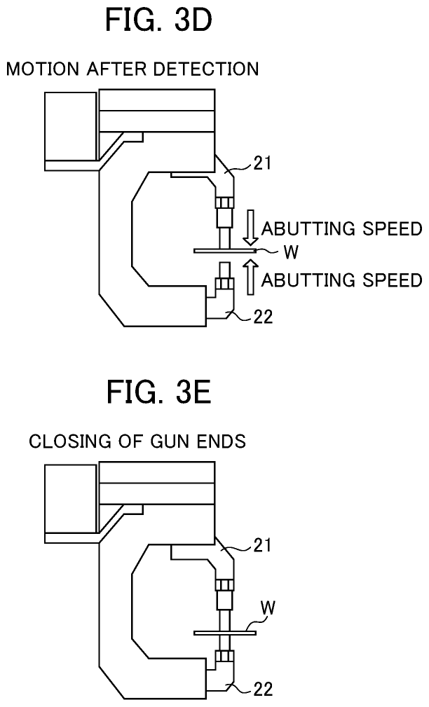

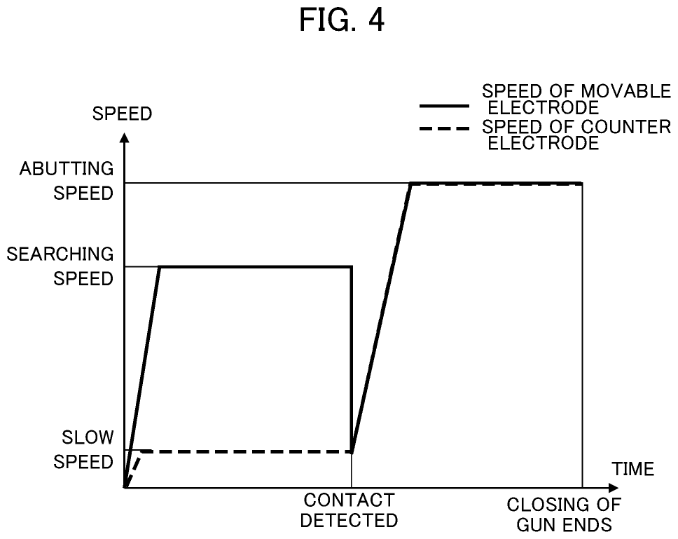

FIGS. 3A to 3E are views illustrating the motion of the movable electrode 21 and counter electrode 22 according to the first embodiment. FIG. 4 is a graph illustrating speed changes of the movable electrode 21 and counter electrode 22 according to the first embodiment.

As shown in FIG. 3A, with the workpiece W disposed between the movable electrode 21 and the counter electrode 22, the motion controller 411 starts an action of closing the spot welding gun 20.

When the action of closing the spot welding gun 20 starts, the motion controller 411 moves the movable electrode 21 at the searching speed and moves the counter electrode 22 at the slow speed as shown in FIG. 3B.

As shown in FIG. 4, the searching speed is a speed at which the movable electrode 21 moves to detect the workpiece W and is set sufficiently higher than the slow speed. The low speed is sufficiently lower than the searching speed, for example, about 1 mm/s to 2 mm/s. Thus, the counter electrode 22 is not stationary, but moves only a small distance.

When the workpiece detector 412 detects the workpiece W as shown in FIG. 3C, the motion controller 411 decelerates the movable electrode 21 to the slow speed as shown in FIG. 4.

After decelerating the movable electrode 21, the motion controller 411 accelerates the movable electrode 21 to the abutting speed as shown in FIG. 3D. The abutting speed is set sufficiently higher than the slow speed. The motion controller 411 accelerates the counter electrode 22 to the abutting speed to move to the target position calculated by the contact position estimator 413.

Then, as shown in FIG. 3E, the motion controller 411 brings the movable electrode 21 and the counter electrode 22 into contact with the workpiece W as shown in FIG. 3E to finish the action of closing the spot welding gun 20.

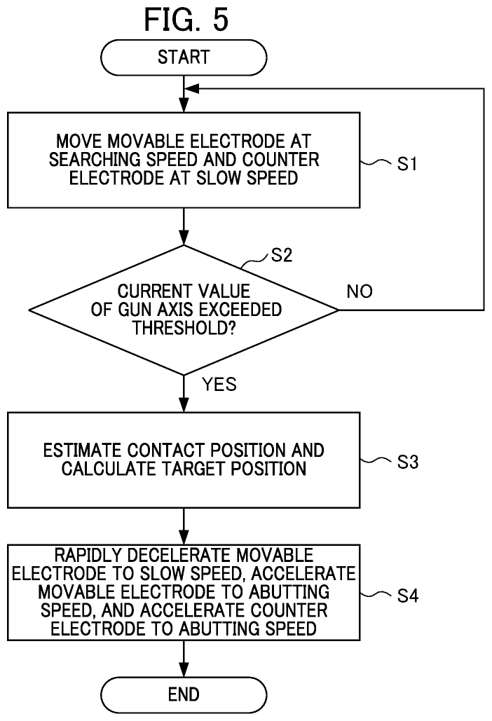

FIG. 5 is a flowchart of the action of closing the spot welding gun 20 by the welding gun control device 40 according to the first embodiment. In Step S1, with the workpiece W disposed between the movable electrode 21 and the counter electrode 22, the motion controller 411 moves the movable electrode 21 at the searching speed and moves the counter electrode 22 at the slow speed.

In Step S2, the workpiece detector 412 acquires the current value of the servomotor 24 as the operating status of the servomotor 24. The workpiece detector 412 determines whether the acquired current value of the servomotor 24 exceeds a threshold T1. If the current value exceeds the threshold T1 (YES is selected), the workpiece detector 412 determines that the movable electrode 21 and the workpiece W make contact with each other. Thus, the workpiece detector 412 detects the workpiece W, and the process proceeds to Step S3. If the current value is equal to or less than the threshold T1 (NO is selected), the workpiece detector 412 determines that the movable electrode 21 and the workpiece W are not in contact with each other, and the process returns to Step S1.

In Step S3, the contact position estimator 413 estimates the position of contact between the movable electrode 21 and the workpiece W and calculates the target position of the counter electrode 22.

In Step S4, the motion controller 411 decelerates the movable electrode 21 to the slow speed. After decelerating the movable electrode, the motion controller 411 accelerates the movable electrode 21 to the abutting speed higher than the slow speed. When the workpiece detector 412 detects the workpiece W, the motion controller 411 accelerates the counter electrode 22 to the abutting speed to move to the target position calculated by the contact position estimator 413. Then, the motion controller 411 brings the movable electrode 21 and the counter electrode 22 into contact with the workpiece W to finish the action of closing the spot welding gun 20.

### Second Embodiment

An action of closing the spot welding gun 20 by a welding gun control device 40 according to the second embodiment will be described below. The welding gun control device 40 according to the second embodiment is different from the welding gun control device of the first embodiment in that flexible control is used to detect the workpiece W with the movable electrode 21 and a threshold T2 is used to determine whether the workpiece W is detected.

Specifically, with the workpiece W disposed between the movable electrode 21 and the counter electrode 22, the motion controller 411 moves the movable electrode 21 at the searching speed and moves the counter electrode 22 or the workpiece W at the slow speed lower than the searching speed by flexile control. The flexible control means control that allows a control target to follow an external force. The flexible control can be achieved by, for example, limiting the output of motor torque of the servomotor 24 or reducing position/speed loop gain.

The workpiece detector 412 also acquires the speed of the servomotor 24 as the operating status of the servomotor 24. The workpiece detector 412 determines whether the movable electrode 21 and the workpiece W are in contact with each other based on whether the acquired speed of the servomotor 24 falls below the threshold T2. Thus, the workpiece detector 412 detects the workpiece W.

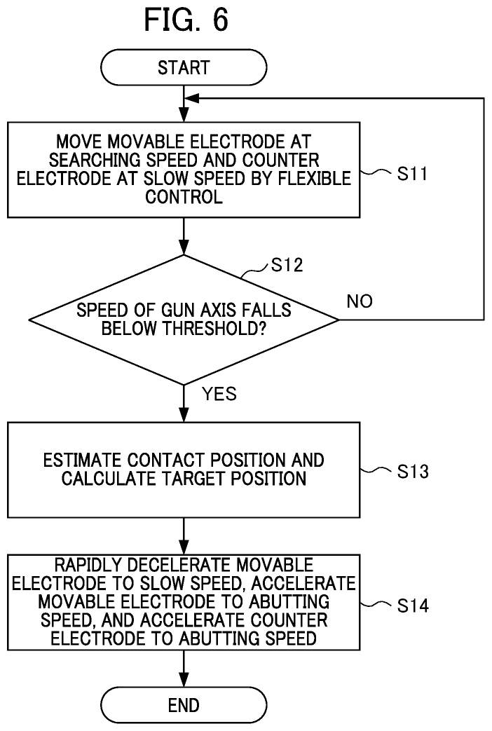

FIG. 6 is a flowchart of the action of closing the spot welding gun 20 by the welding gun control device 40 according to the second embodiment. In Step S11, with the workpiece W disposed between the movable electrode 21 and the counter electrode 22, the motion controller 411 moves the movable electrode 21 at the searching speed and moves the counter electrode 22 at the slow speed.

In Step S12, the workpiece detector 412 acquires the speed of the servomotor 24 as the operating status of the servomotor 24. The workpiece detector 412 determines whether the acquired speed of the servomotor 24 falls below the threshold T2. If the speed of the servomotor 24 falls below the threshold T2 (YES is selected), the workpiece detector 412 determines that the movable electrode 21 and the workpiece W make contact with each other. Thus, the workpiece detector 412 detects the workpiece W, and the process proceeds to Step S13. If the speed of the servomotor 24 is equal to or more than the threshold T2 (NO is selected), the workpiece detector 412 determines that the movable electrode 21 and the workpiece W are not in contact with each other, and the process returns to Step S11.

In Step S13, the contact position estimator 413 estimates the position of contact between the movable electrode 21 and the workpiece W and calculates the target position of the counter electrode 22.

In Step S14, the motion controller 411 decelerates the movable electrode 21 to the slow speed. After decelerating the movable electrode, the motion controller 411 accelerates the movable electrode 21 to the abutting speed higher than the slow speed. When the workpiece detector 412 detects the workpiece W, the motion controller 411 accelerates the counter electrode 22 to the abutting speed to move to the target position calculated by the contact position estimator 413. Then, the motion controller 411 brings the movable electrode 21 and the counter electrode 22 into contact with the workpiece W to finish the action of closing the spot welding gun 20.

In the embodiments described above, the motion controller 411 moves the movable electrode 21 at the searching speed and moves the counter electrode 22 at the slow speed with the workpiece W disposed between the movable electrode 21 and the counter electrode 22. Instead of moving the counter electrode 22 at the slow speed, the motion controller 411 may move the workpiece W at the low speed by controlling a support which is not shown. Specifically, the motion controller 411 may move the movable electrode 21 at the searching speed and move the workpiece W at the slow speed with the workpiece W disposed between the movable electrode 21 and the counter electrode 22.

Although the spot welding system 1 of the embodiments described above includes the C-type spot welding gun 20, the spot welding gun system 1 may include other spot welding gun. The other spot welding gun may be, for example, an X-type spot welding gun and a fixed spot welding gun.

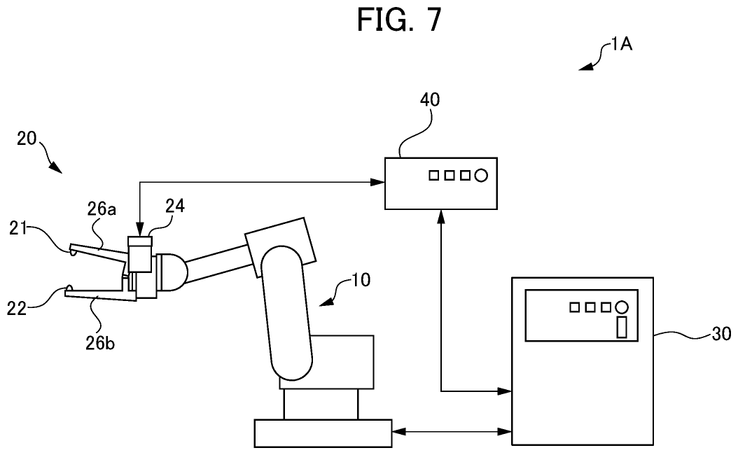

FIG. 7 is a view illustrating a configuration of a spot welding system 1A including an X-type spot welding gun 20. As shown in FIG. 7, the X-type spot welding gun 20 includes a pair of gun arms 26a and 26b that can be opened and closed, a movable electrode 21 attached to an end of the gun arm 26a, and a counter electrode 22 attached to an end of the gun arm 26b.

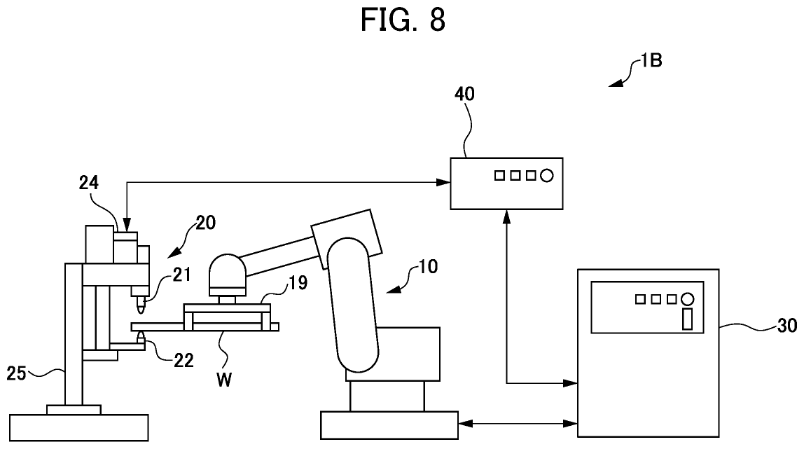

FIG. 8 is a view illustrating a configuration of a spot welding system 1B including a fixed spot welding gun 20. As shown in FIG. 8, the spot welding system 1B supports the spot welding gun 20 with a gun stand 25 fixed in position and holds the workpiece W with a robot hand 19 at the arm end of the robot 10. Thus, the spot welding system 1B drives the robot 10 to move the workpiece W relative to the spot welding gun 20 so that the workpiece W is disposed between the movable electrode 21 and the counter electrode 22. The spot welding system 1A including the X-type spot welding gun 20 and the spot welding system 1B including the fixed spot welding gun 20 can achieve the action of closing the spot welding gun 20 with the welding gun control device 40, just like the spot welding system 1 described above.

As described above, the welding gun control device 40 for controlling the spot welding gun 20 that pressurizes and welds the workpiece W between the movable electrode 21 driven by the servomotor and the counter electrode 22 facing the counter electrode 21 includes: the motion controller 411 that moves the movable electrode 21 at the searching speed and moves the counter electrode or 22 the workpiece W at the slow speed lower than the searching speed, the workpiece W being disposed between the movable electrode 21 and the counter electrode 22; and the workpiece detector 412 that detects the workpiece W based on the operating status of the servomotor 24 driving the movable electrode 21 while the motion controller 411 is moving the movable electrode 21 and the counter electrode 22.

The welding gun control device 40 moves, not only the movable electrode 21 at the searching speed, but also the counter electrode 22 or the workpiece W at the slow speed. Thus, when the counter electrode 22 is accelerated to the abutting speed, friction torque is compensated from the start and the change in speed can be reduced, as compared to the situation where the counter electrode 22 is kept stationary before the detection of the contact. This welding gun control device 40 can achieve smooth acceleration of the counter electrode 22 or the workpiece W, reducing the vibration of the spot welding gun 20. Further, the welding gun control device 40 allows the counter electrode 22 or the workpiece W to move at the slow speed, reducing the deviation of the spot welding gun from the instructed path due to, for example, decreased backlash between gears.

The workpiece detector 412 determines whether the movable electrode 21 and the workpiece W are in contact with each other based on the current value or speed of the servomotor 24 acquired as the operating status of the servomotor 24. When the workpiece detector 412 detects the workpiece W, the motion controller 411 decelerates the movable electrode 21 to the slow speed, accelerates the movable electrode 21 to the abutting speed higher than the searching speed and the slow speed after the deceleration of the movable electrode 21, and then accelerates the counter electrode 22 to the abutting speed.

The welding gun control device 40 thus causes rapid deceleration of the movable electrode 21 upon detection of the contact, reducing the load applied to the workpiece W at the detection of the workpiece W. The welding gun control device 40 moves the counter electrode 22 at the slow speed before the detection of the contact. Thus, when the counter electrode 22 is accelerated to the abutting speed, friction torque is compensated from the start and the change in speed can be reduced, as compared to the situation where the counter electrode 22 is kept stationary before the detection of the contact. This welding gun control device 40 can achieve smooth acceleration of the counter electrode 22, reducing the vibration of the spot welding gun 20. Further, the welding gun control device 40 allows the counter electrode 22 to move at the slow speed, reducing the deviation of the spot welding gun from the instructed path due to, for example, decreased backlash between gears.

The welding gun control device 40 further includes the contact position estimator 413 that estimates the position of contact between the movable electrode 21 and the workpiece W and calculates the target position of the counter electrode 22 when the workpiece detector 412 detects the workpiece W. The motion controller 411 moves the counter electrode 22 to the target position calculated by the contact position estimator 413. Thus, the welding gun control device 40 can move the counter electrode 22 to the target position.

The servomotor 24 for driving the movable electrode 21 may be driven by an external controller. This allows the welding gun control device 40 to drive the movable electrode 21 using the external controller. The workpiece detector 412 may determine whether the movable electrode 21 and the workpiece W are in contact with each other by using an external sensor. This allows the welding gun control device 40 to determine whether the movable electrode 21 and the workpiece W are in contact with each other using the external sensor.

The spot welding system 1 described as the embodiments of the present invention can be implemented by hardware, software, or a combination of the hardware and the software. A method of control by the spot welding system 1 can also be implemented by hardware, software, or a combination of the hardware and the software. The expression “implemented by the software” means that a computer reads and executes a program to implement the functions of the control system or the control.

The program is stored in various types of non-transitory computer readable media and supplied to the computer. The non-transitory computer readable media include various types of tangible storage media. Examples of the non-transitory computer readable media include a magnetic recording medium (e.g., a hard disk drive), a magneto-optical recording medium (e.g., a magneto-optical disk), a compact disc read only memory (CD-ROM), a CD-R, a CD-R/W, and a semiconductor memory (e.g., a mask ROM, a programmable ROM (PROM), an erasable PROM (EPROM), a flash ROM, and a random access memory (RAM)).

The embodiments have been described above as advantageous embodiments of the present invention, but the scope of the present invention is not limited to the embodiments alone. Various types of modifications can be made without departing from the spirit of the present invention.

### EXPLANATION OF REFERENCE NUMERALS

1 Spot welding system
10 Robot
11 Base
12 Lower arm
13 Upper arm
14 Arm end
15 Servomotor
15a Encoder
20 Spot welding gun
21 Movable electrode
22 Counter electrode
23 Gun arm
23a Frame
24 Servomotor
24a Encoder
30 Robot control device
40 Welding gun control device
41 Controller
42 Storage
411 Motion controller
412 Workpiece detector (detector)
413 Contact position estimator

1. A welding gun control device for controlling a welding gun that pressurizes and welds a welding target between a movable electrode driven by a servomotor and a counter electrode facing the movable electrode, the welding gun control device comprising:
a motion controller that moves the movable electrode at a first speed and moves the counter electrode or the welding target at a second speed lower than the first speed, the welding target being disposed between the movable electrode and the counter electrode; and
a detector that detects the welding target based on an operating status of the servomotor driving the movable electrode while the motion controller is moving the movable electrode and the counter electrode.

2. The welding gun control device according to claim 1, wherein the detector detects the welding target by determining whether the movable electrode and the welding target are in contact with each other based on a current value or speed of the servomotor as the operating status of the servomotor, and
the motion controller decelerates the movable electrode to the second speed when the detector detects the welding target and accelerates the movable electrode to a third speed higher than the second speed after decelerating the movable electrode, and accelerates the counter electrode to the third speed when the detector detects the welding target.

3. The welding gun control device according to claim 2, further comprising:
a contact position estimator that estimates a position of contact between the movable electrode and the welding target and calculates a target position of the counter electrode when the detector detects the welding target,
wherein the motion controller moves the counter electrode at the third speed to the target position calculated by the contact position estimator.

4. The welding gun control device according to claim 1, wherein the servomotor that drives the movable electrode is driven by an external controller.

5. The welding gun control device according to claim 2, wherein the detector determines whether the movable electrode and the welding target are in contact with each other using an external sensor.

6. A welding gun control system, comprising:
a welding gun that includes a movable electrode driven by a servomotor and a counter electrode facing the movable electrode and pressurizes and welds a welding target between the movable electrode and the counter electrode; and
a welding gun control device that controls the welding gun,
wherein the welding gun control device includes:
a motion controller that moves the movable electrode at a first speed and moves the counter electrode or the welding target at a second speed lower than the first speed, the welding target being disposed between the movable electrode and the counter electrode; and
a detector that detects the welding target based on an operating status of the servomotor driving the movable electrode while the motion controller is moving the movable electrode and the counter electrode.

7. A welding system, comprising:
a welding gun that includes a movable electrode driven by a servomotor and a counter electrode facing the movable electrode and pressurizes and welds a welding target between the movable electrode and the counter electrode;
a welding gun control device that controls the welding gun;
a robot that holds the welding gun or the welding target and includes a robot servomotor that drives a plurality of axes; and
a robot control device that controls the servomotor of the welding gun and the robot servomotor,
wherein the welding gun control device includes:
a motion controller that moves the movable electrode at a first speed and moves the counter electrode or the welding target at a second speed lower than the first speed, the welding target being disposed between the movable electrode and the counter electrode; and
a detector that detects the welding target based on an operating status of the servomotor driving the movable electrode while the motion controller is moving the movable electrode and the counter electrode.
